(19) United States
(12) Patent Application Publication
(10) Pub. No.: US 2002/0110228 A1
(43) Pub. Date: Aug. 15, 2002

(54) Portable telephone/remote control device

(76) Inventors: Lawrence Silverman, Newtown Square, PA (US); Lawrence A. Husick, Malvern, PA (US)

Correspondence Address: Robert S. Lipton, Esquire, LIPTON, WEINBERGER & HUSICK, 201 North Jackson Street, P.O. Box 934, Media, PA, 19063-0934, US

(21) Appl. No.: 10/068,566

(22) Filed: Feb. 6, 2002

Related U.S. Application Data
(63) Continuation-in-part of application No. 09/071,500, filed on May 1, 1998, now abandoned.
(60) Provisional application No. 60/045,370, filed on May 2, 1997.

(51) Int. Cl. H04M 1/00; H04M 9/00; H04B 1/00

(52) U.S. Cl. 379/110.01

(57) ABSTRACT

The present invention relates to a method of initiating an object-agent interaction to initiate telephone calls automatically from a browser on a computer network, and particularly from a network computer having dedicated apparatus for controlling a telephone. The invention also relates to a portable telephone/remote control.

This application is a continuation in part of utility patent application number 09/071,500 filed May 1, 1998 which claims the benefit of the filing date of provisional patent application number 60/045,370 filed May 2, 1997.

### BACKGROUND OF THE INVENTION

This invention relates generally to a network browser and, more specifically, to a method and apparatus for initiating a telephone call directly and automatically from a network browser. The invention also comprises a remote control device for communicating with and controlling a network computer connected to a network such as a local area network or Internet. The remote control device incorporates a combination cordless telephone and infrared remote control for electronic devices. The term “network computer” includes any microprocessor-equipped device connected to a network.

Network browsers (and especially internet browsers) running on a standalone computer, client computer or a network computer for accessing information from a network (or the word wide web) are well-known. The computer is typically connected to a communications network via a network card or a modem.

Generally speaking, the browser only operates as a viewing device except for “mail-to” command. A user calls the “mail-to” command and inputs an electronic mail address into the network browser is “mail-to” command. This invokes an electronic mail editor within the browser in order to create a message that eventually gets transmitted over the network to the specified electronic mail address.

### SUMMARY OF THE INVENTION

The subject invention relates to making a network browser more into an operating system by adding to its functionality. Specifically, the subject invention would set up a new tag, for example, “phone-to”, which when followed by a telephone number invokes a telephone editor within the browser in order to send a telephone call to the owner of that telephone number.

The apparatus of the present invention may provide multiple data paths from a cordless telephone/remote control device to the network computer equipped with a browser. A user may simultaneously control televisions, videotape systems, set-top boxes, and other home appliances while carrying on telephone conversations, reviewing data retrieved from the network and controlling the browser. Appliances and other devices under the control of the cordless telephone/remote control are referred to herein as “slave devices.” The cordless telephone/remote control device may incorporate the features of a personal digital assistant (“PDA”) such as the Palm Pilots.

Other objects and advantages of the present invention will be apparent upon reference to the accompanying description when taken in conjunction with the following drawings.

### BRIEF DESCRIPTION OF THE DRAWINGS

Additional objects and features of the invention will be more readily apparent from the following detailed description and appending claims when taken in conjunction with the drawings, in which:

FIG. 1 is a schematic block diagram of an embodiment of a network computer incorporating the present invention.

FIG. 2 is a schematic diagram of a portable telephone/remote control of the present invention.

### DESCRIPTION OF THE PREFERRED EMBODIMENT

The present invention relates to a method of initiating an object-agent interaction to initiate telephone calls automatically from a browser on a computer network, and particularly from a network computer having dedicated apparatus for controlling a telephone. The present invention also relates to a portable telephone/remote control device, as described below.

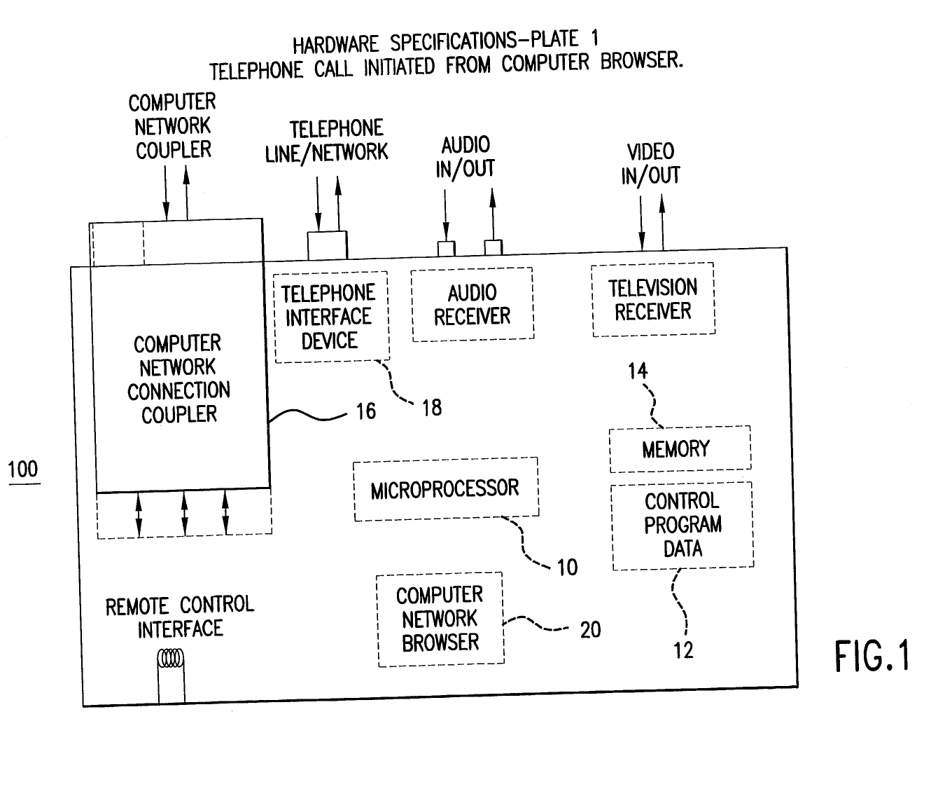

Referring to FIG. 1, there is shown a network computer 100 having the following primary components: a microprocessor 10, a program/data controller 12, memory 14, network connection 16, and a telephone interface device 18. In the preferred embodiment, each network computer 100 is connected to a network through the network connection 16. The network connection 16 may be a modem for connecting to the internet or another communication interface for connecting to a localized network (e.g., a local area network—LAN).

For the purposes of this application, it will be assumed that the network computer 100 utilizes a modem for connection to the world wide web and that the computer's memory stores, at least, an operating system and a network browser 20. However, it is believed that the present invention provides a step in which the browser will eventually function as an operating system.

The present invention is an integrated system which uses a telephone that is controlled by the computer via the network browser and which has a tag verb, (for example an HTML, of “call-to”. When the “call-to” object is called by the network browser 20, the user only needs to enter a valid telephone number or internet phone call address to initiate a voice telephone call. The computer would use whatever means possible to connect the telephone call to the desired party. More importantly, the user does not have to specify the path and the means that the computer selects would be invisible to the user. Currently, the two most common ways of connecting the voice telephone call would be through the use of an Internet phone (IP) or a separate plain old telephone system (POTS) telephone line.

The subject invention would connect the telephone call port-to-port without discriminating as to which technology is used to connect the call. That is, the subject invention bridges conventional Internet phone to POTS.

The subject invention can be used in combination with a data detection technology, such as Apple Computers Data Detectors, currently available from Apple Computer of Cupertino, California. Apple's Data Detectors recognize particular formats of information and extract that information for a particular action.

In a related matter, another tag verb, (e.g., an HTML labeled “page-to”can send a numeric or an alpha-numeric message to a pager. Once again, the connections for, and the method of sending, such a message is invisible to the user.

Another possible extension is to have the browser recognize an HTML tag verb corresponding to “fax-to”, which would take the target information and transmit it in a format of a Group 3 or Group 4 fax to a remote facsimile machine. Once again, the computer system would use either the internet or a POTS line to make the connection, and the connection would be invisible to the user.

A conventional set of integrated circuits for detecting ring signals, dual tone multi-frequency signals, modulated digital information, such as “caller ID” and similar information may be integrated into an network computer. In addition, an interface provider to permit a user to control and configure such integrated circuits from a network browser screen may be implemented. In particular, by providing multiple telephone line connections, a voice telephone call or facsimile transmission may be initiated or accepted under browser control.

Preferably, a conventional modem chipset may be employed with browser based software to interpret “distinctive ringing” signals (duration coding or the telephone ring signal), as well as to decode caller ID signals and route the presentation of information to a user through the browser software.

In addition, a combination cordless telephone, personal digital assistant (PDA, or a type similar to the Palm Pilot), and infrared remote control for electronic devices is provided to function as a telephone and information appliance adjunct to the network computer device disclosed herein. The cordless telephone may use conventional radio frequency technology (PCS, 900 Mhz, 47 Mhz, IrDA, etc.). By providing multiple data paths from the cordless telephone/remote control to the network computer equipped with a browser and connected to a digital network, the user may simultaneously control televisions, videotape systems, set-top boxes, and other home appliances while carrying on telephone conversations, reviewing data retrieved from the network, and controlling the browser. A form-factor of approximately 2.5 inches wide, 4 inches tall, and less than 0.5 inches thick facilitates ease-of-use, and the dot addressable screen and stylus input provided allows the network computer to selectively control the remote device and upload data to be presented to the user.

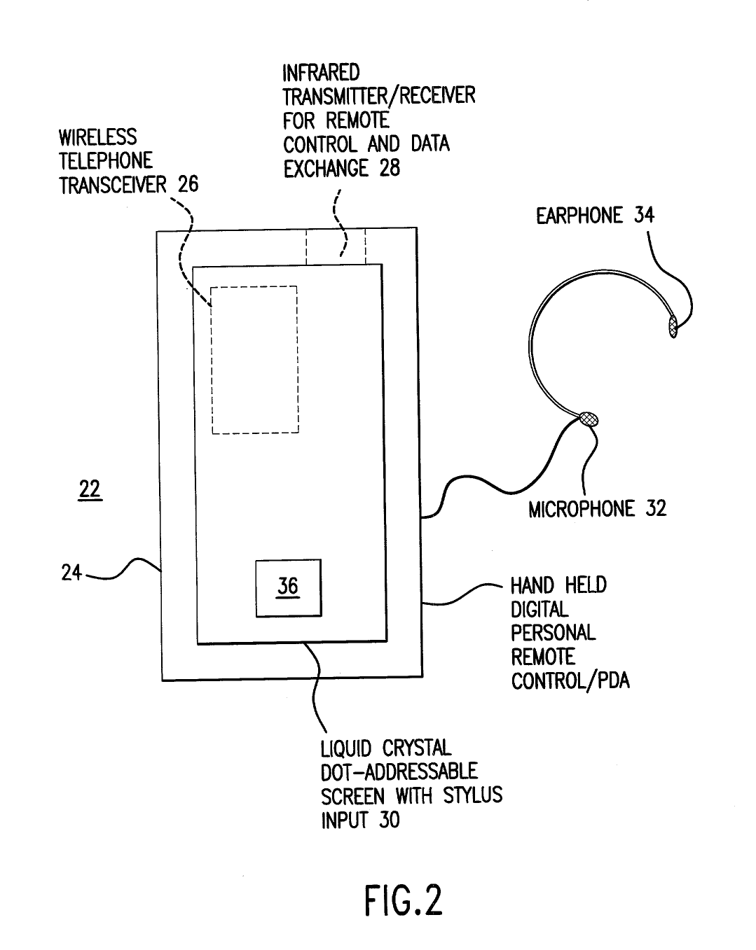

A portable, handheld cordless telephone/remote control device 22 is presented in FIG. 2. The cordless telephone/remote control device 22 includes a body 24, wireless telephone transceiver 26 and infrared transmitter/receiver 28 for transmitting and receiving information between the cordless telephone/remote control 22 and the network computer 100. The wireless telephone transceiver 26 and the infrared transmitter/receiver 28 also allow the cordless telephone/remote control 22 to communicate with other devices and systems. The information transmitted and received may include transmission of voice, images and data.

The cordless telephone/remote control 22 includes a liquid crystal dot-addressable screen with stylus/touchscreen input 30 for input of data by a user and for display of information to the user. A microphone 32 allows audio data, particularly voice data, to be input into the cordless telephone/remote control device 22. An earphone 34 allows a user to hear audio information conveyed to the user by the cordless telephone/remote control unit 22.

The cordless telephone/remote control device 22 serves at least a control function and a telephony function. In its control function, the cordless telephone/remote control 22 acts as a remote control for televisions, video systems, set-top boxes and other home appliances by direct communication with the controlled device through the wireless telephone transceiver 26 or the infrared transmitter/receiver 28. The cordless telephone/remote control also may input data into the network computer 100 through the wireless telephone transceiver 26 or the infrared transmitter/receiver 28, thereby controlling devices that are under the control of the network computer 100. The cordless telephone/remote control thereby may control appliances or automation and control systems in homes, offices or other person occupied structures. The cordless telephone/remote control 22 may be equipped with a pointing device 34 such as a mouse, joystick or arrow keys to assist in inputting data to the network computer 100.

The cordless telephone/remote control device 22 provides a telephony function through connection to the conventional public switch telephone network by conventional radio frequency telephone technology using the wireless telephone transceiver 26. In addition, the cordless telephone/remote control device 22 may transmit and receive voice and/or video data from the network computer 100 using the wireless telephone transceiver 26 or the infrared transmitter/receiver 28. As directed by a user, the network computer 100 may initiate or receive telephone calls over the network using the browser 20.

The cordless telephone/remote control device 22 may retrieve telephone numbers from its internal memory, may retrieve telephone numbers from the network using the network computer 100 or may retrieve telephone numbers from the network computer memory.

The cordless telephone/remote control 22 also may provide the functions of a personal digital assistant.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

We claim:

1. A telephone interface device for use in a network browser program running on a computer to communicatively couple an incoming telephone line from a central office of a telephone service provider, comprising:
(a) a tone decoder responsive to a tone sequence appearing on said internal signal line, and operative to decode the tone sequence into a plurality of bit signals and to input the bit signals to said computer;
(b) a ring detector communicatively coupled between said internal signal line, and said computer, said ring detector being operative to generate a A predetermined voltage for input to said computer if a ring signal is detected on said internal signal line;
(c) a remote off-hook detector communicatively coupled between said internal signal line and said computer, said
(d) ring detector being responsive to a voltage appearing on said internal signal line and operative to generate a predetermined voltage for input to said computer if another of said plurality of telephone sets and/or answering machines is in the off-hook condition and causes the voltage to appear on said internal signal line;
(e) a local phone connector communicatively coupled to said local device terminals and having a ring signal line and a tip signal line, said ring signal line being communicatively coupled to said circuit node; and
(f) a local phone off-hook detector communicatively coupled to said computer and to said tip signal line, said local phone off-hook detector being responsive to a voltage appearing on said tip signal line, and operative to generate a voltage for input to said computer if a telephone set coupled to said local device terminals is an off-hook condition.

2. The telephone interface device of claim 1, and further comprising greeting signal generator means responsive to a signal from said computer and operative to generate a greeting signal for transmission to an outside caller via said telephone interface.

3. A local telephone network, comprising a plurality of interface devices capable of being initiated by a network browser running on a computer, each of said devices being communicatively coupled to a telephone set and/or answering machine and to each other, and to a telephone company's central office via an incoming telephone signal line, each of said devices having a unique extension code sequence assigned thereto.

4. The local telephone network as recited in claim 3, further comprising a ring generator coupled between the telephone set and the incoming telephone signal line and operative to generate a ring signal on said telephone signal line in response to an input from said browser.

5. A portable telephone/remote control device comprising:
a. a computer adapted to send and to receive telephone calls over a network;
b. a portable telephone/remote control body;
c. a transmitter/receiver within said body adapted to send and to receive signals to and from said computer when said transmitter/receiver is at some distance of separation from said computer such that said transmitter/receiver may communicate with said computer;
d. means attached to said body to convert sound energy into electrical energy for transmission by said transmitter/receiver to said computer;
e. means attached to said body to convert signals received from said computer by said transmitter/receiver to sound energy such that a user may hear communications received from said computer.

6. The portable telephone/remote control device of claim 5, further comprising said transmitter/receiver being adapted to communicate directly with a plurality of slave devices such that said portable telephone/remote control device may control remotely said slave devices.

7. The portable telephone/remote control device of claim 6 further comprising said computer being adapted to control said plurality of slave devices, said computer being programmed to respond to commands from said transmitter/receiver such that said portable telephone remote control device may control remotely said slave devices.

8. The portable telephone/remote control device of claim 7, said slave devices being selected from the list comprising video devices, audio devices, set top boxes, home appliances and automation and control systems for person-occupied structures.

9. The portable telephone/remote control device of claim 8, said transmitter/receiver being selected from the list comprising infrared transmitter/receiver, wireless telephone transceiver, and both infrared transmitter/receiver and wireless telephone transceiver.

10. The portable telephone/remote control device of claim 9, said transmitter/receiver including a wireless telephone transceiver located within said body, said wireless telephone transceiver including means to connect said portable telephone/remote control to a public switch telephone network.

11. The portable telephone/remote control device of claim 10, said means for connection to said public switch telephone network being a radio frequency connection.

12. The portable telephone/remote control device of claim 11 further comprising means to input data to said transmitter/receiver for transmission to said computer.

13. The portable telephone/remote control device of claim 12, said means to input data comprising a touch screen attached to said body.

14. The portable telephone/remote control device of claim 12, said means to input data comprising a pointing device affixed to said body.

15. The portable telephone/remote control device of claim 12 further comprising said portable telephone/remote control device having the functions of a personal digital assistant.
